(19) United States
(12) Patent Application Publication
(10) Pub. No.: US 2014/0060942 A1
(43) Pub. Date: Mar. 6, 2014

(54) Measurable Collection Container for construction waste

(71) Applicant: Liangguo Qu, Toronto (CA)

(72) Inventor: Liangguo Qu, Toronto (CA)

(21) Appl. No.: 13/601,271

(22) Filed: Aug. 31, 2012

(51) Int. Cl. G01G 19/08

(52) U.S. Cl. 177/136

(57) ABSTRACT

It is an invention of a measurable collection container. The characteristic lies in that: the collection container, with weight sensor and digital weight indicator, can be used any time to collect the garbage, to weigh it and to calculate the charge based on the weight data. On two sides of the collection container are two pickup sleeves by which the truck can easily hold the measurable collection container with the garbage in it. On one side of the collection container is a movable door through which the bulky garbage can be taken into easily. There are four wheels in the bottom of the collection container, which makes the moving of the collection container more easily.

### THE FIELD OF INVENTION

The present invention pertains to a measurable collection container for the construction waste.

### THE BACKGROUND OF THIS INVENTION

The conventional way to load the construction waste now is to put the waste into the trash container and ship it by the trash trucks to the transfer station. Usually it is charged based on the full container of different existing size, which is unfair for the project whose garbage amount is less than one container because the minimum quantity of loading requested for one time has to be one container. Besides, the trash container currently used is very heavy and it needs to be shipped by special trash truck, which lacks of flexibility of shipping the garbage for the smaller construction company or decorating company.

In order to solve the above problem, a new type of measurable collection container for the construction waste is designed in this patent. It is not the construction trash bin as commonly used, but a container which collects the construction waste from the trash bin into it and weighs before being consolidated into the trailer of the truck. Therefore, the construction company or the decorating company can call the trash truck company to come any time. The construction waste is to be weighed and paid on the spot of construction site before being shipped, providing great convenience of delivering the construction waste for the construction company or decorating company.

### CONTENT

1. According to the claims, this measurable collection container for construction waste is made of metal. Most of the nonmetal material can not sustain the pounding effect caused by the construction waste because it is bulky and heavy. Other hard material like reinforced glass can also be used but the cost is pretty high. So the material of metal is recommended for this collection container.

2. The main characteristic for this measurable collection container lies in that it has a digital weight sensor (FIG. 1-1) and a weight indicator (FIG. 1-2). The weight sensor is installed at the bottom of the collection container and the weight indicator screen is set in one side of the collection container which can be easily seen. When the waste is put into the collection container, the weight data is displayed on the digital screen through the sensor.

3. There is one pickup sleeve set on each side of this measurable collection container, (FIG. 1-3), the purpose of which is: when the collection container with garbage is ready to be delivered, the front forks of the trash truck can be extended to hold the pick up sleeves, lifting the collection container up and dump the garbage into the trailer of the trash truck (FIG. 2). The pickup sleeves are fixed onto the two sides of the collection container by the rivets.

4. For the convenience of loading the bulky and heavy garbage into the collection container with little effort, a movable door is designed in one side of the collection container through the door spindle (FIG. 3) and the other side can be opened and closed with a bolt to fix the door tightly and safely. (FIG. 4)

5. There are four wheels on the bottom of this measurable collection container (FIG. 1-4), the purpose of which facilitates the moving of it; there are 4 base plates designed respectively at the corners of the bottom of the collection container (FIG. 5-1); On each of the base plate is a hole (FIG. 5-2); the stand of the wheel comprises 2 parts, a thick one and a thinner one (FIG. 5-3 and FIG. 5-4); the way of the thinner part to be inserted into the holes in the base plate (FIG. 5-5); the thick part is stuck into the bottom of the collection container and the weight is transferred to the four wheels (FIG. 5-6).

6. A weight sensor is designed at the bottom of the measurable collection container (FIG. 6). The weight sensor comprises the base plate (FIG. 6-1), the holes on the base plate, the connection stand for the base plate and the spring (FIG. 6-2), the sensor (FIG. 6-3) and the stand of the wheel (FIG. 6-4). The weight sensor is connected with the digital weight indicator on the side of the measurable collection container, transferring the digital weight data of the garbage to the screen of the indicator.

### ATTACHED DRAWING

FIG. 1: The front and lateral view of the measurable collection container for the construction waste, and it is made of metal, at the bottom of which is the weight sensor (FIGS. 1-1) and 4 wheels (FIG. 1-4). On the 2 sides of the collection containers are the pickup sleeves fixed by the rivets. (FIG. 1-3)

FIG. 2: It shows the way of working between the measurable collection container and the trailer of the trash truck. The front forks of the trash truck (FIG. 2-1) is extended to hold the pickup sleeves (FIG. 2-2) which is fixed on the two sides of the collection container already weighted. The pickup sleeves lift the measurable collection container with garbage in it and empty it into the trailer of the trash truck. The trailer of the trash truck is now commonly used and is not included in the patent applied.

FIG. 3: and FIG. 4 shows that there is a movable door on one side of this measurable collection container which helps to move the bulky garbage more easily. One side of the door can be opened and the other side is connected through the door spindle (FIG. 3). The door can be closed and fixed with a bolt (FIG. 4). Two bolts are specially designed in order to close the door tightly.

FIG. 5: It shows the design of the bottom of this measurable collection container. FIG. 5-1 is the base plate for the wheels; FIG. 5-2 is the hole in the base plate; FIG. 5-3 is the thinner stand; FIG. 5-4 is the thick stand, FIG. 5-5 shows the way of the thinner stand inserting into the hole of the base plate; FIG. 6 are the wheels.

FIG. 6: It shows the design of the weight sensor. FIG. 6-1 is the base plate for the weight sensor and the base plate contacts the ground. FIG. 6-2 is the elastic spring between the sensor and the base plate, and the elastic spring will ensure the base plate can contact the ground. When the garbage inside is filled in, the collection container will sink, leading to the contact of the weight sensor with the base plate, then the weight data will be displayed on the screen. FIG. 7 shows the details. FIG. 6-3 shows the position of the weight sensor and the weight data is shown on the screen through the sensor.

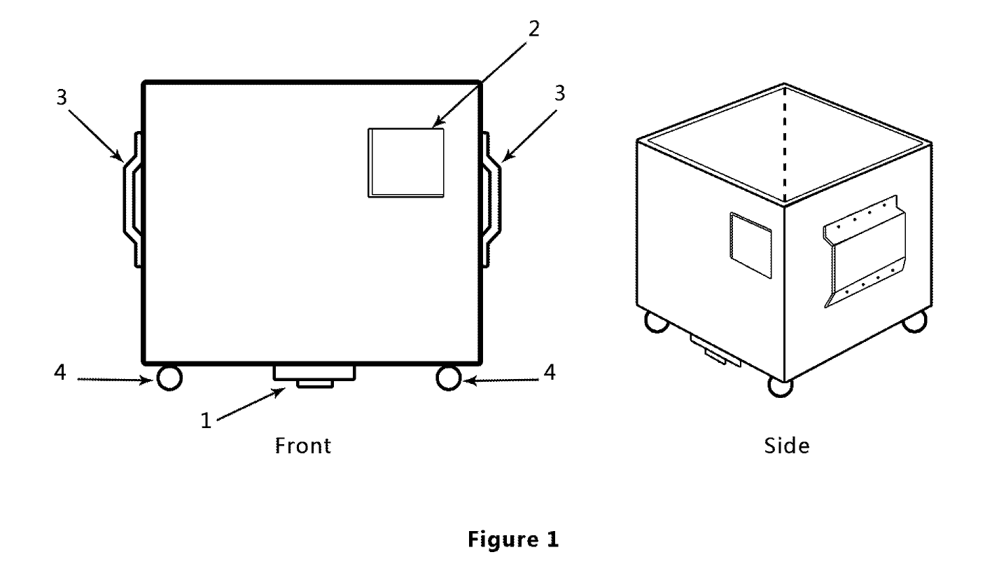

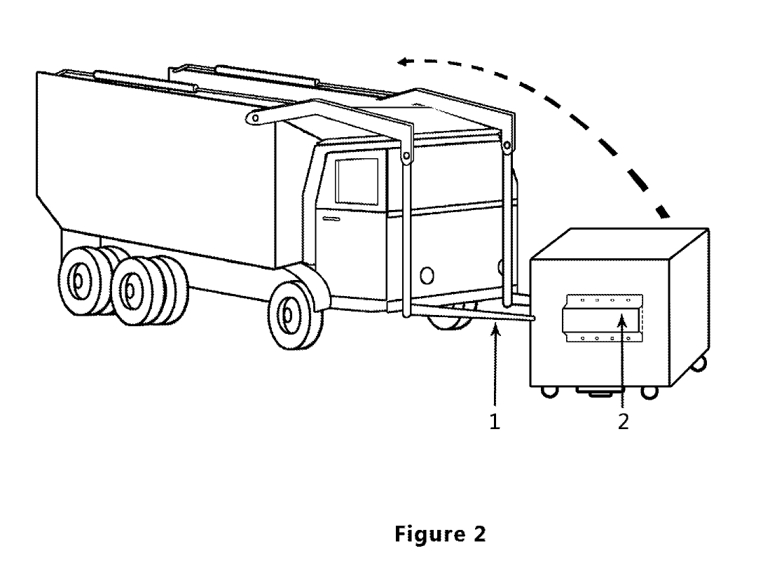

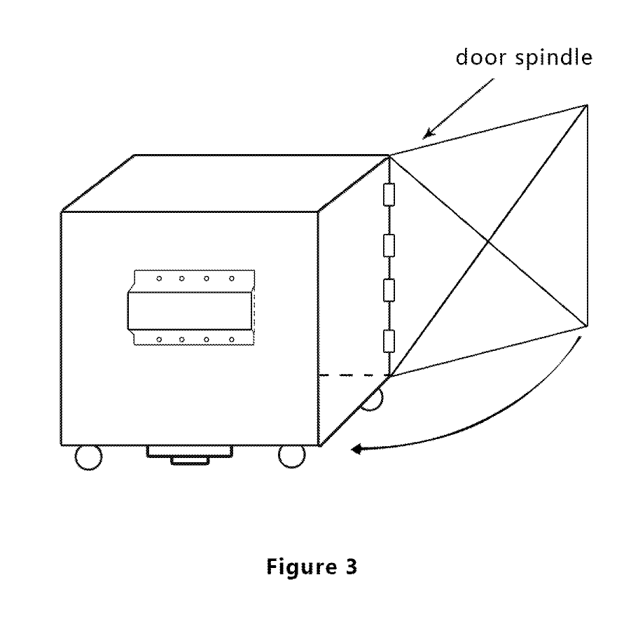

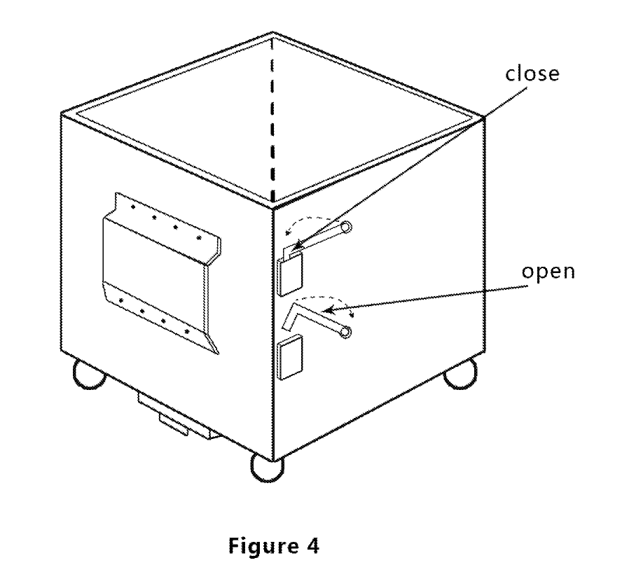

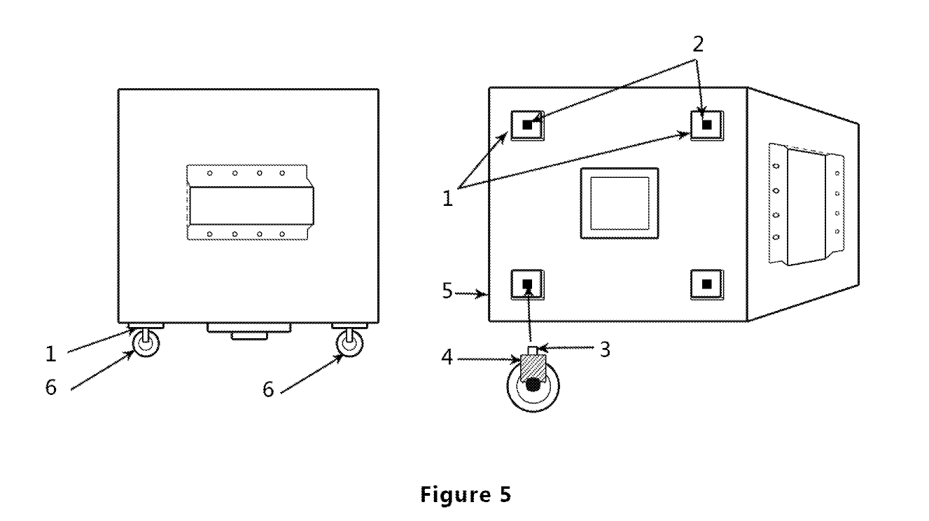

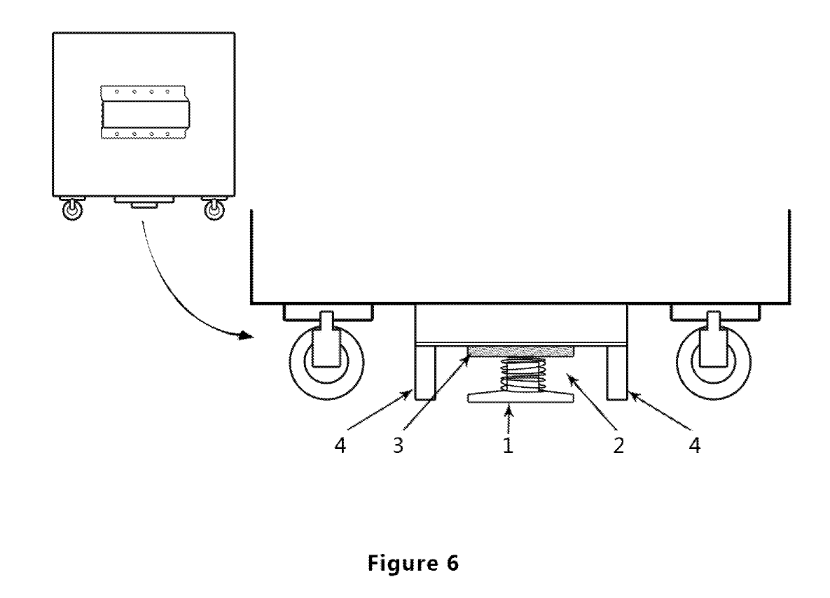

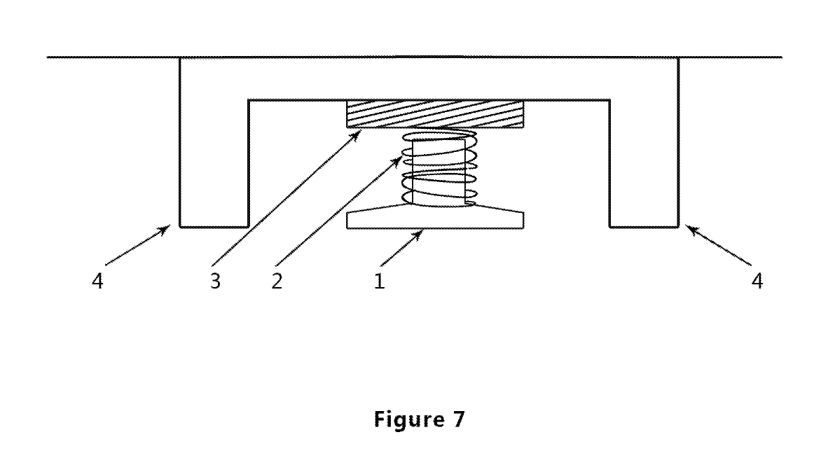

### APPLICATION

When garbage is loaded into the collection container, the container will sink owing to the weight of the garbage, giving the pressure to the weight sensor. Then the spring is compressed, the base plate connects the weight sensor which calculates the weight and the weight data will be displayed on the indicator. It is charged based on the weight data. The front forks of the trash truck lift the collection container by holding the pickup sleeves and then empty the garbage into the trailer of the truck. After being emptied, the collection container can be prepared for next use.

1. An invention of measurable collection container for construction waste, the characteristic lies in that: there is a sensor and weight indicator installed in the collection container, two sides of which are two pickup sleeves. One side is designed as a movable door. This measurable collection container has four wheels.

2. According to claim 1, the sensor is set at the bottom of the collection container and it is connected with the weight indicator installed on the side of the collection container.

3. According to claim 1, there are pickup sleeves welded tightly to the body of this measurable collection container for construction waste.

4. According to claim 1, there is a movable door in one side of this collection container, one side of which is connected with the collection container and the other side can be opened and closed.

5. According to claim 1, four wheels are set to the four corners of this measurable collection container which can be moved by these wheels.

6. According to claim 1, this measurable collection container for construction waste is made of metal or any other hard material.
